(19) United States
(12) Patent Application Publication
(10) Pub. No.: US 2020/0094748 A1
(43) Pub. Date: Mar. 26, 2020

(54) GEAR RACK

(71) Applicant: NORCO INDUSTRIES, INC., Compton, CA (US)

(72) Inventor: Bernard F. GARCEAU, Vandalia, MI (US)

(21) Appl. No.: 16/577,685

(22) Filed: Sep. 20, 2019

Related U.S. Application Data
(60) Provisional application No. 62/734,545, filed on Sep. 21, 2018.

(51) Int. Cl. B60R 9/08; B60R 9/06; B60R 9/10; B62H 3/08

(52) U.S. Cl. CPC B60R 9/08; B62H 3/08; B60R 9/10; B60R 9/06

(57) ABSTRACT

Disclosed are gear racks capable of securing one or more articles and/or equipment, such as bicycles and/or kayaks, grills, tables, luggage, containers, etc. The gear rack may be mounted to a frame of an enclosure, and the gear rack may be pinned into various positions, for example, a working position or a stored position.

### CROSS-REFERENCE TO RELATED APPLICATIONS

This application claims benefit of U.S. Provisional Application No. 62/734,545, filed Sep. 21, 2018, the disclosure of which is incorporated by reference in its entirety.

### BACKGROUND

Recreational vehicles have dramatically grown in popularity over the years and have therefore created a substantial market for mounted equipment racks. Various types of equipment racks have been developed, such as top-mounted equipment racks and front-frame-mounted equipment racks. Such equipment racks may be configured to store various types of outdoor equipment such as bicycles, kayaks, canoes, various types of boards, skis, etc. Top-mounted equipment racks, however, are often hard to utilize, especially when attempting to mount thereto equipment like bicycles on top of taller vehicles like sport utility vehicles, pick-up trucks, recreational vehicles, etc. Indeed, front-frame-mounted equipment racks are also difficult to utilize as they may be difficult to access due to their proximity to the tow vehicle and/or because it may be ideal to mount the equipment rack in front of the self-powered recreational vehicle. Moreover, using top-mounted equipment racks on such taller vehicles reduces overhead clearance, which could result in damage to the bicycle and/or vehicle if driven underneath an object without sufficient clearance. Rear-mounted equipment racks, while being easier to access, are not adapted to mount to all types of vehicles and in some instances may inhibit and/or obstruct utilization of the vehicle's trunk compartment. Thus, a gear rack is needed that may install to various types of vehicle frames, may store various types of gear (including recreational including), and may be adjustable.

### SUMMARY

Described herein are various embodiments of a gear rack for a vehicle frame. The gear rack may comprise a structure that is rotatably coupled to the vehicle frame, the structure supporting at least one tray defining an upper cargo surface. In some examples, the at least one tray includes a plurality of wheel wells formed into the upper cargo surface. In some examples, the structure includes one or more removable struts. In some examples, the structure includes an opening configured to receive an end of a piece of equipment, such as an end of a kayak.

In some examples, the gear rack comprises a platform coupled to the frame at a hinge, wherein the platform may be oriented in one or more positions relative to the frame depending on an alignment between the platform and the hinge.

In some examples, the gear rack comprises a structure rotatably coupled to the vehicle frame via a bracket system secured to the vehicle frame, the structure supporting at least one tray defining an upper cargo surface, the at least one tray having a plurality of wells recessed into the upper cargo surface, wherein the structure is configured to attach to the bracket system in at least one orientation defined by the alignment between a locator hole of the structure and a locator aperture of the bracket system.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIGS. 1A and 1B are isometric views of an exemplary gear rack mounted on a rear side of an enclosure when in working and stored positions, according to one or more embodiments.

FIG. 1C is a close-up view of the hinge of the gear rack when in stored position as shown in FIG. 1B.

FIG. 1D is a close-up view of an alternate hinge of the gear rack when in stored position as shown in FIG. 1B.

FIG. 2A is an isometric top view of the gear rack of FIGS. 1A and 1B.

FIG. 2B is a bottom perspective view of the gear rack of 2A.

FIG. 3 illustrates an arm of the gear rack, according to one or more examples.

FIG. 4A illustrates the gear rack engaged with a set of pins, according to one or more examples.

FIG. 4B illustrates the gear rack engaged with a set of pins that are differently sized than the pins in FIG. 4A, according to one or more examples.

FIG. 5A illustrates a close up of the hinges of the gear rack comprising a bracket system utilizable with the pins of FIG. 4B when the gear rack is in a working position, according to one or more examples.

FIG. 5B illustrates a partially exploded view of the gear rack of FIG. 5A wherein one of the bracket systems is shown unassembled.

FIG. 6A illustrates a close up of the hinges of the gear rack comprising a bracket system of FIG. 5A when the gear rack is in a stored position, according to one or more examples.

FIG. 6B illustrates a partially exploded view of the gear rack of FIG. 6A wherein one of the bracket systems is shown unassembled.

FIGS. 7A-7B are close-up illustrations of the hinges of the gear rack comprising an alternate bracket system utilizable with the pins of FIG. 4A to position the gear rack in a stored and working position, respectively, according to one or more examples.

FIG. 8 illustrates the gear rack, when in a working (or horizontal) position, having a bicycle support structure, according to one or more embodiments of the present disclosure.

FIG. 9 illustrates the gear rack of FIG. 8 having bicycles stored thereon.

FIG. 10 illustrates the gear rack, when in a working (or horizontal) position, having a kayak support structure, according to one or more embodiments of the present disclosure.

FIG. 11 illustrates the gear rack of FIG. 10 having kayaks stored thereon.

FIG. 12 illustrates the gear rack having alternate configuration for receiving kayaks.

FIGS. 13A-13C illustrate the gear rack having alternate configuration for receiving bicycles.

FIGS. 14A-14C illustrate a bracket system that may be utilized to couple the gear rack to a vehicle frame, according to one or more embodiments of the present disclosure.

### DETAILED DESCRIPTION

The present disclosure describes a vehicle-mounted equipment or gear rack capable of securing one or more articles of equipment (e.g., bicycles, canoes, kayaks, paddleboards, surfboards, luggage, containers, boxes, grills, tabletops, bench or seat assemblies, picnic table assemblies, etc.). Such vehicle-mounted gear racks enhance storage capacity of the vehicle on which they are mounted, and also enhance features or accommodations that may or may not otherwise be provided on the vehicle. In addition, such vehicle-mounted gear racks permit users to more easily access the equipment when installed at a rear end of a recreational vehicle such as a fifth wheel, travel trailer, motor-coach, etc., as compared to commercially available vehicle equipment mounts. Though, the presently disclosed vehicle-mounted gear racks may be installed on various other types of vehicles, including automobiles, construction equipment, material handling equipment, and other types of commercial vehicles, etc.

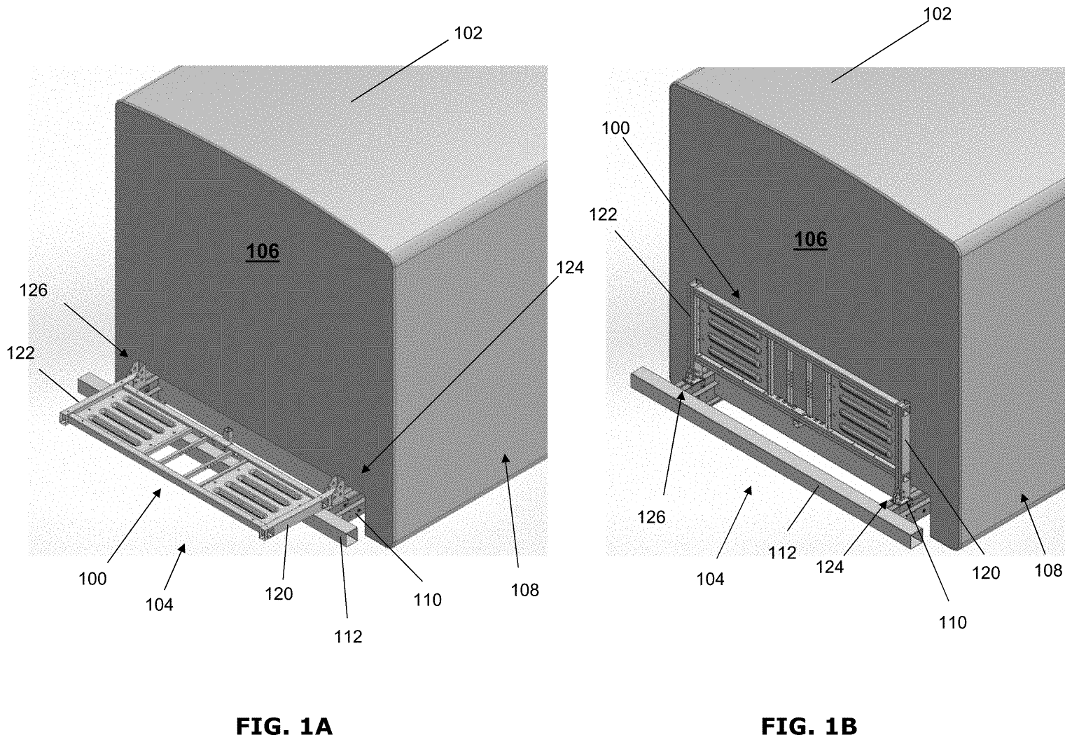

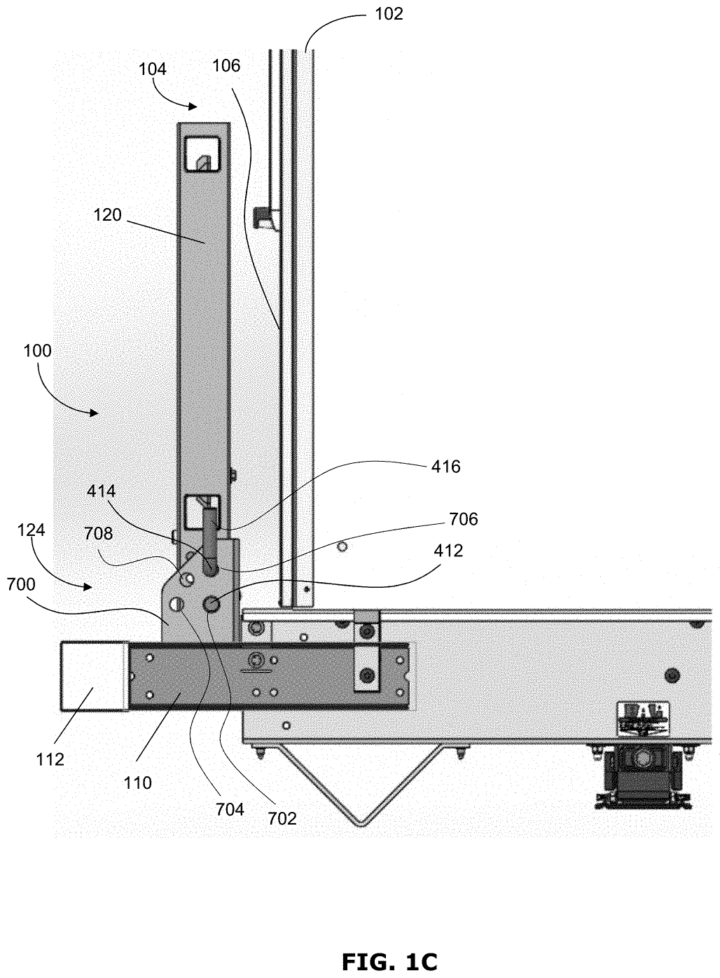

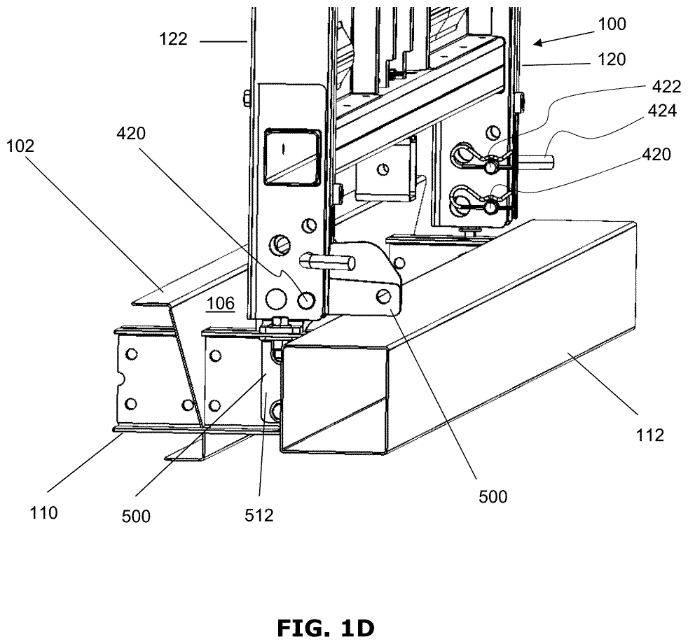

FIGS. 1A-1B are isometric views of an exemplary gear rack 100 mounted on an enclosure 102, according to one or more embodiments. FIG. 1A illustrates the gear rack 100 in a deployed (or extended or un-folded) position, whereas FIG. 1B illustrates the gear rack 100 of FIG. 1A when folded into a fully stowed (or unextended or folded) position. In other examples, the gear rack 100 may be configured to be secured at one or more partially deployed positions between the illustrated deployed or stowed positions, and/or configured to be extended and secured beyond the deployed position illustrated in FIGS. 1A and 1B.

In the illustrated example, the gear rack 100 is mounted to a rear 104 of the enclosure 102. Thus, the gear rack 100, when folded into its stored (or stowed) position (FIG. 1B) may be substantially parallel with a rear wall 106 of the enclosure 102 and, when unfolded into the working (or deployed) position (FIG. 1A), may extend perpendicularly from the rear wall 106 of the enclosure 102. In other examples, the gear rack 100 may be mounted at different portions of the enclosure 102, for example, at one or more sides 108 and/or at a front (not illustrated) of the enclosure 102.

The enclosure 102 illustrated in FIGS. 1A-1B is just one example enclosure 102 that can suitably incorporate the principles of the present disclosure. Indeed, many alternative designs and configurations of the enclosure 102 may be employed, without departing from the scope of this disclosure. Thus, the enclosure 102 may include various types of structures, for example, a travel trailer, a recreational vehicle, a utility trailer, a fifth wheel, a motor coach, etc.

As shown in FIGS. 1A and 1B, the frame 110 extends underneath the enclosure 102 and projects outwardly from the rear side 104 of the enclosure 102 so as to extend beyond the rear wall 106. In this example, the frame 110 includes one or more frame members extending longitudinally along a length of the enclosure 102. As shown, the frame 110 extends underneath the enclosure 102 and projects outwardly from the rear side 104 of the enclosure 102 so as to extend beyond the rear wall 106. In this example, the frame 110 supports a bumper 112, and the frame 110 positions the bumper 112 outward from the rear wall 106 of the enclosure. The gear rack 100 is rotatably secured to the frame 110 in a manner allowing the position of the gear rack 100 to be adjusted (or moved or rotated), relative to the frame 110 and the enclosure 102, for example, into the stored (or stowed) position shown in FIG. 1B (and in FIGS. 1C-1D), and then adjusted from that stored position into one or more extended or working or deployed positions such as, for example, the working position shown in FIG. 1A. In FIG. 1A, the gear rack 100 has been adjusted into a deployed position, where its structure is resting on the bumper 112. In other examples, however, the gear rack 100 may be adjusted into one or more different deployed positions where the gear rack 100 is oriented differently, with respect to the frame 110, than as illustrated in FIG. 1A. Also, in some examples, the gear rack 100 may be adjusted into one or more different stored positions where the gear rack 100 is oriented differently, with respect to the frame 110, than as illustrated in FIG. 1B (and in FIGS. 1C-1D).

The gear rack 100 may be rotatably mounted to the frame 110 in a variety of manners. FIG. 1C illustrates a close up of the gear rack 100 when mounted to the frame 110 in the stored position, according to one or more embodiments of the present disclosure, whereas FIG. 1D illustrates an alternate example of the gear rack 100 being mounted to a frame 110 in the stored position.

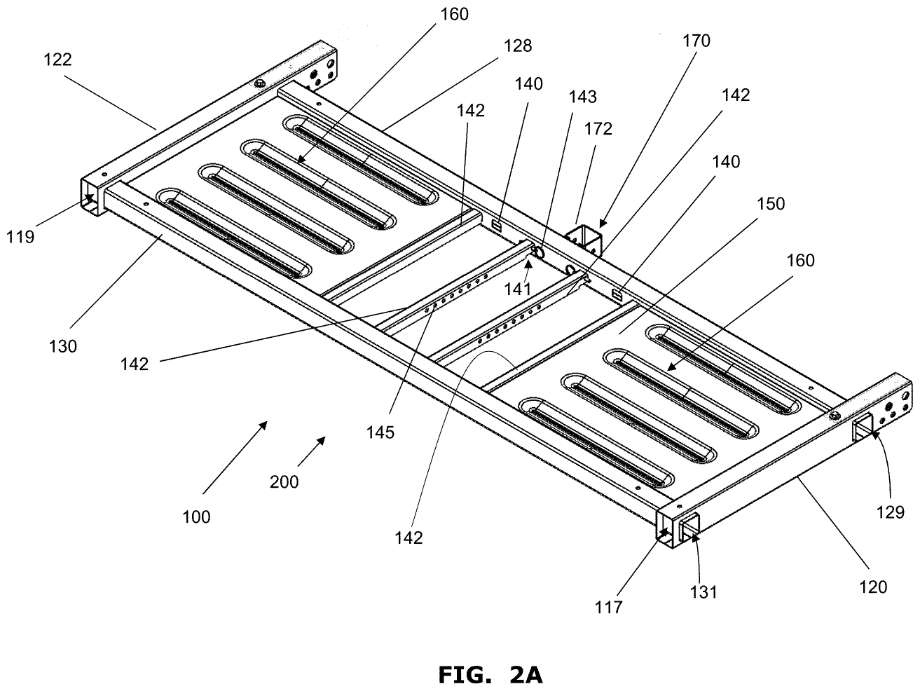

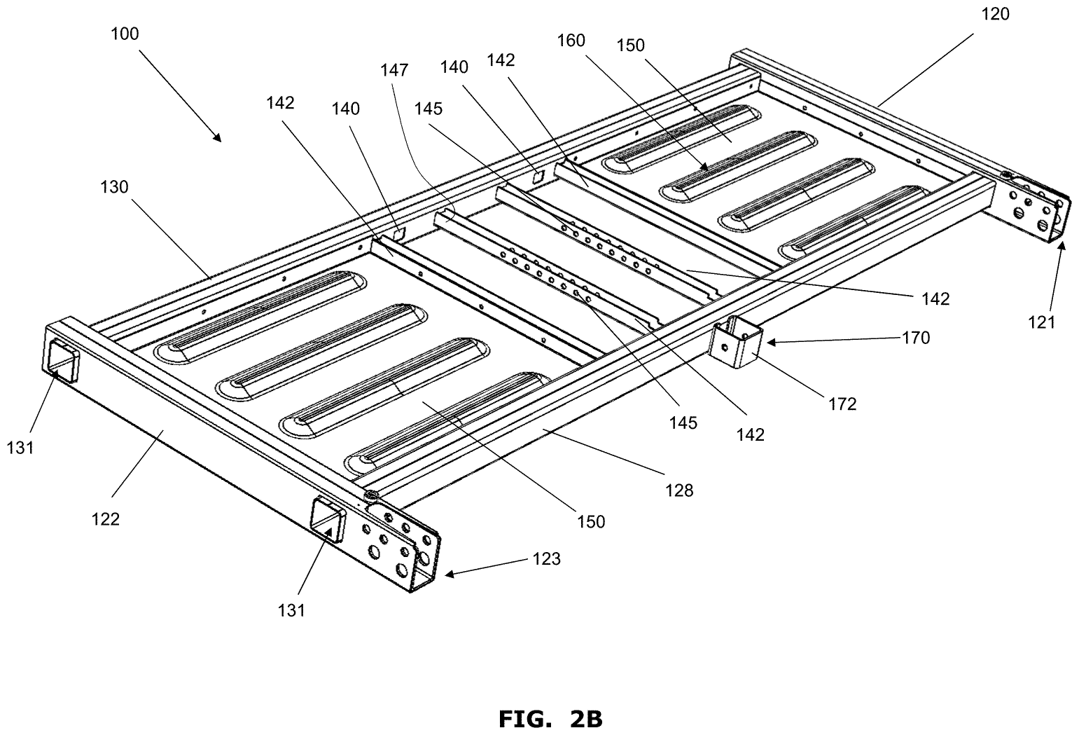

FIGS. 2A and 2B illustrate top and bottom views of a structure 200 of the gear rack 100 when uninstalled from the enclosure 102, according to one or more embodiments. The structure 200 comprises a flip down stand having a cargo surface on which various items may be placed, such as containers, luggage, boxes, recreational equipment, sporting goods/equipment, etc. FIG. 2A illustrates an upper side of the structure 200 configured as the cargo surface, whereas FIG. 2B illustrates the opposite side of the structure. As illustrated, the structure 200 defined by the gear rack 100 is rotatably secured to a frame 110 of the enclosure 102. As more fully described below, the structure 200 is a platform or a stand configured to support various different components or assemblies, such as a tray, a bike rack assembly, a kayak rack assembly, after-market mountable equipment (e.g., mountable grills, tables, benches), etc. The various components of the gear rack 100 may be made of any rigid or semi-rigid material, such as a metal or a plastic. In some examples, the gear rack 100 is predominantly made from aluminum or stainless steel.

In the illustrated example, the gear rack 100 includes a pair of arms 120,122. The arms 120,122 are rotatably coupled to the frame 110 such that they may rotate relative to the frame 110, for example, as illustrated in FIGS. 1C and 1D. Here, the arms 120,122 are coupled to the frame 110 via a pin, which thereby defines a joint or hinge 124,126 with an axis of rotation for the gear rack 100 (obscured from view). The arms 120,122 project radially outward from the axis of rotation of the gear rack 100, and may rotate about axis of rotation into various radially extending positions radially extending from the axis, for example, a working position and a stored position.

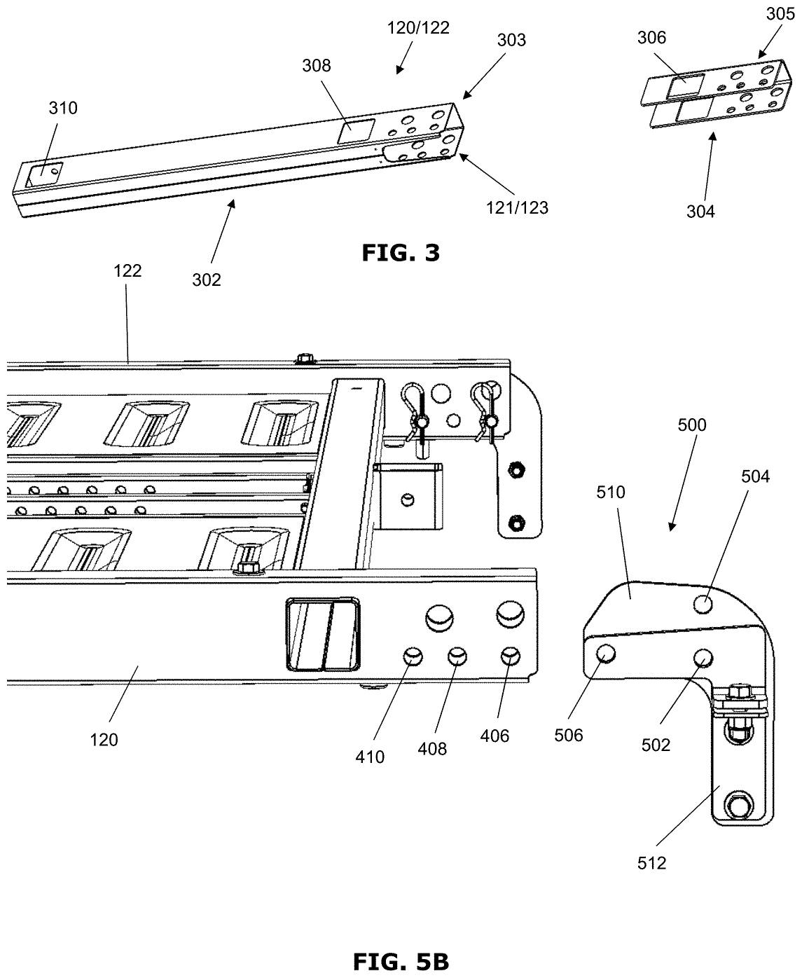

As further described below with reference to FIG. 3, the arms 120,122 may be monolithic or integral structures or comprised of two or more members. In some examples, the arms 120,122 are hollow and/or channeled. In the illustrated example, the arms 120,122 are channels and also include a cut-out 121,123 so as to expose an interior portion of the arms 120,122 at which the hinges 124,126 will be defined by pinning and provide an envelope within which the frame member 110 may be received. The arms 120,122 may thus have one or more exposed openings 117,119 at which equipment, such as tables, grills, etc. may be installed.

The gear rack 100 also includes a pair of cross-members 128,130 arranged between the arms 120,122. As illustrated, the cross-members 128,130 laterally extend between the arms 120,122 and, together with the arms 120,122, define a frame of the gear rack 100. The cross-members 128,130 may each be individual channel members extending between the arms 120,122. In some examples, one or more of the cross-members 128,130 may be configured as a telescoping channel member that expand or contract. In this manner, the end-user may adjust the lateral extension of the cross-members 128,130 to accommodate the width or spacing between the arms 120,122, which may vary depending on the particular frame 110 on which the gear rack 100 is installed. Thus, the cross-members 128,130 may be adjustable such that the gear rack 100 may be utilized regardless of the various lateral dimensions (or widths) of the frame members of the frame 110 on which the arms 120,122 are coupled. The cross-members 128,130 may be hollow channels and thus may each have one or more exposed openings 129,131 at which mountable equipment, such as tables, grills, picnic tables, coolers, etc., may be installed. For example, a picnic table assembly (not illustrated) may be configured with guides that slide into the cross-members 128,130, through the exposed openings 129,131, such that the gear rack 100 supports a set of benches and tables which users may utilize. Other equipment may be similarly configured to adapt to the openings 129,131 of the cross-members 128,130.

The cross-members 128,130 may also each include one or more corresponding recesses or mounting locations configured to receive various types of supports or frame members. In the illustrated example, the cross-members 128,130 include a plurality of recesses 140 (some of which are obscured from view) configured to receive a plurality of struts or interior frame members 142. Here, the recesses 140 on the cross-members 128,130 are interiorly facing such that the recesses 140 on the cross-member 128 (i.e., that face away from the rear wall 106) and the recesses (obscured from view) on the cross-member 130 (i.e., that face the rear wall 106) face each other, and there are four (4) of the interior frame members 142 longitudinally extending (i.e., perpendicular to cross-members 128,130) between corresponding pairs of the recesses 140. However, the recesses 140 on either or both of the cross-members 128,130 may also extend fully through such that they both face towards and away from the rear wall 106. In other non-illustrated examples, either or both of the cross-members 128,130 may include additional recesses provided on an upper and/or lower surface of the cross-members 128,130 and/or the arms 120,122.

The struts or interior frame members 142 may be removable. In the illustrated example, the struts or interior frame members 142 are interiorly removable. Here, the interior frame members 142 each include a cut away portion 141 proximate to the cross-member 128 and pinned into location via a pin 143. Removal of the pin 143 permits the cut away portion 141 of the interior frame members 142 to slide into the cross-member 128 such that an opposite portion 147 of the interior frame members 142 may be removed from the cross-member 130.

The gear rack 100 may also include one or more trays 150. The trays 150, together with the interior frame members 142, may define a platform or surface on which various types of equipment may be stored. In the illustrated example, there are two (2) of the trays 150 suspended within the gear rack 100; however, more or less than two (2) of the trays 150 may be provided in other examples. As illustrated, the trays 150 are suspended within the frame defined by the arms 120,122 and the cross-members 128,130, and the interior frame members 142.

Various means may be utilized to secure or fasten the trays 150 within the gear rack 100. In some examples, the trays 150 may be integrally attached (e.g., via welding and/or mechanical fasteners) to one or more of the arms 120,122 and/or cross-members 128,130. In some examples, the tray 150 may also (or instead) be integrally attached (e.g., via welding, mechanical fastener, integral formation, etc.) to the interior frame member 142 proximate to the tray 150. Here, for example, the trays 150 may integral with one or more of the interior frame members 142, such that the trays 150 are secured within the gear rack 100 by installing the interior frame members 142 within the mounting recesses 140 of the cross-members 128,130. In some examples, the trays 150 include exteriorly facing (i.e., facing towards and away from the rear wall 106) protrusions (obscured from view) configured to be inserted into the recesses 140 in the cross-members 128,130, and in some examples, lateral protrusions of the trays 150 may extend within similarly provided recesses in the arms 120,122 and interior frame members 142. In the illustrated examples, some of the interior frame members 142 include mounting holes 145, which may be utilized to support the tray 150 (or other equipment or components as described below). In some examples, the trays 150 may include flanges (not shown) that are configured to drape over one or more of the arms 120,122, cross-members 128,130, and/or the interior frame members 142, such that the trays 150 may be set or may rest within windows defined by the arms 120,122, cross-members 128,130, and/or the interior frame members 142.

As mentioned, the trays 150 may be utilized as a platform or surface on which various types of equipment may be stored. In the illustrated example, the trays 150 include a plurality of stampings or wells 160. The wells 160 may be formed via a variety of methods and, in one example, are stamped into the trays 150. Here, the wells 160 are laterally extending wheel wells arranged to receive front and rear wheels of a bicycle. Also, the wheel wells 160 are recessed into an upper surface of the trays 150. In this manner, the wheel wells 160 do not include any raised portions, extending upward from the upper surface of the trays 150, that may impact or interfere with items placed on the upper surface of the trays 150. Accordingly, the wheel wells 160 won't inhibit any items from being placed flat on the upper surface of the trays 150. The trays 150 may be mountable at different lateral positions within gear rack 100 to accommodate different sized gear, such as one or more bicycles. For example, the trays 150 may be mounted within any of the recesses 140 of the cross-members 130,132 such that the lateral positioning of (and/or width between) the trays 150 may be adjusted to move the wheel wells 160 laterally right or left and/or increase or decrease the lateral spacing between the wheel wells 160.

The gear rack 100 may also include an accessory mount 170. The accessory mount 170 may be utilized to fasten one or more structures, as described below, for helping secure equipment to the gear rack 100, for example, bicycles, boards, kayaks, etc. The accessory mount 170 includes a base (obscured from view) and an adapter portion 172 configured to receive or mate with additional structures as described herein. The base may be one or more pins installed within the cross-member 128, a sleeve member arranged on the cross-member 128 (between two (2) of the interior frame members 142) and configured to slide laterally along the cross-member 128 such that the lateral position of the accessory mount 170 is adjustable; however, in other examples, the adapter portion 172 may be integrally connected (e.g., welded) directly to the gear rack 100. Here, the adapter portion 172 is a sleeve member configured to receive another structure as detailed herein.

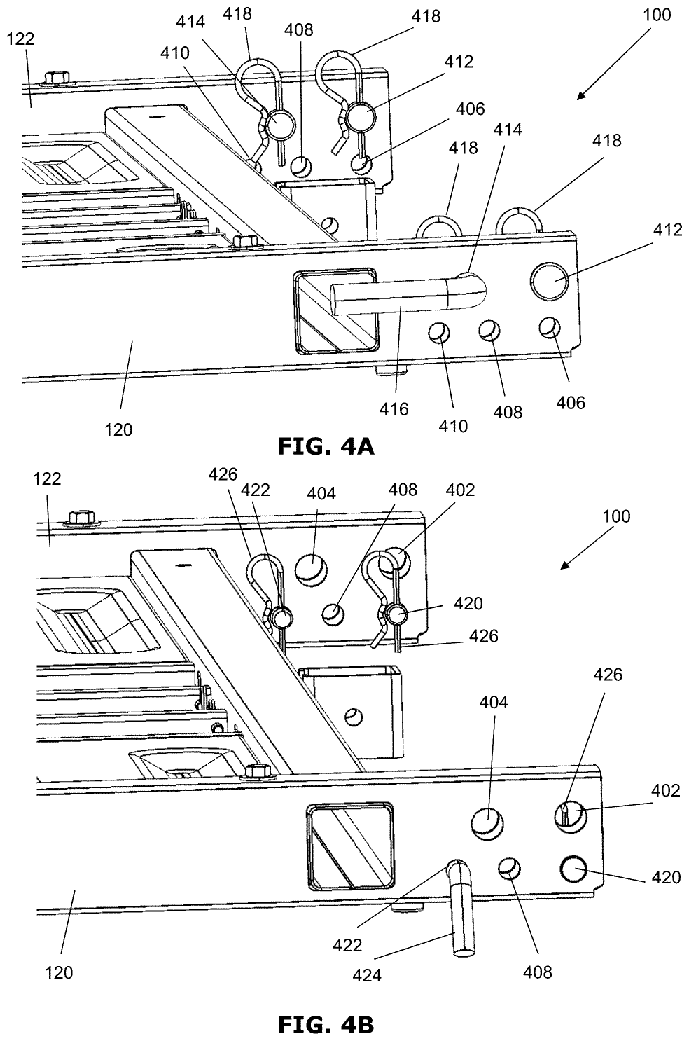

FIG. 3 illustrates the arms 120,122 of the gear rack 100, according to one or more examples. In this example, each of the arms 120,122 is an assembly of a channel member 302 and an insert 304. The channel member 302 is hollow, with the cut-outs 121,123, and configured as a sleeve to receive the insert 302. Here, the insert 304 helps strengthen each channel member 302 of the arm 120,122 at locations/areas proximate to the hinges 124,126. Thus, the channel member 302 and the insert 304 may each include corresponding sets of holes or apertures. Here, for example, the channel member 302 and the insert 304 each include first and second sets of holes at mounting ends 303,305 of the channel member 302 and insert 304, respectively. By assembling the insert 304 within the channel member 302, the sets of holes at the mounting end 303 of the channel member 302 and the corresponding sets of holes at the mounting end 305 of the insert 304 align with each other to define a first set of holes of the arms 120,122 (i.e., the first set of holes 402,404 in FIGS. 4A and 4B) and a second set of holes of the arms 120,122 (i.e., the second set of holes 406,408,410 in FIGS. 4A and 4B). In addition, the channel member 302 and the insert 304 each include a cross-member opening 306,308 that align with each other when the insert 304 is assembled in the channel member 302 to receive a cross-member, or other structural member, etc. of the gear rack 100. Also, the channel member 302 may include additional openings 310 for receiving one or more additional cross-members, or other structural members, etc. of the gear rack 100, and in some (unillustrated) examples, the insert 304 may be provided with sufficient length that it may include a corresponding opening.

The hinges 124,126 may be lockable to secure the tray of the gear rack 100 in one or more positions. For example, the arms 120,122 and/or the hinges 124,126 may include a plurality of slots or apertures through which a pin may be inserted to lock the tray of the gear rack 100 in the fully stowed position, in the fully deployed position, or in one or more positions there-between. Accordingly, the slots or apertures extending through the arms 120,122 may be sized according to the size of mating recesses or apertures in the hinges 124,126, such that a single appropriately sized pin (or rod) may extend through the locator holes in the arms 120,122 when aligned with corresponding holes in the hinges 124,126 (that are connected to the frame 110). As described below, the arms 120,122 may be rotated into a stored position where a locator hole in the arm aligns with a first locking hole in the hinges 124,126 or may be rotated into a working position where the same or different locator hole in the arm 120,122 aligns with a second locking hole in the hinges 124,126.

FIGS. 4A and 4B illustrate the gear rack 100 having different sets of holes arranged to permit locking the gear rack 100 in different positions, according to one or more examples. In the illustrated examples, the gear rack 100 has a first set of holes 402,404 and a second set of holes 406,408,410. In these examples, the first set of holes 402,404 are of a first diameter and thus sized to receive pins of that first diameter, and the second set of holes 406,408,410 are of a second diameter and thus sized to receive pins of that second diameter. Here, a rotational pin 412 and a locking pin 414 having handle 416 are provided in the first set of holes 402,404, and the pins 412,414 may be secured in place via a clip 418. Also, a rotational pin 420 is provided in a first of the second set of holes 406 and a locking pin 422 having handle 424 is provided in one of the remaining second set of holes 408,410. Here, the locking pin 422 is provided in the hole 410 that corresponds with the gear rack 100 being un-folded into its working position. However, the locking pin 422 may be removed from the hole 410, allowing the gear rack 100 to rotate upward, and the locking pin 422 may then be inserted into the second hole 408 to lock the gear rack in a second position. The rotational pin 420 and a locking pin 422 may be secured in place via a clip 426.

Accordingly, the pins 412,414 engaging the arms 120,122 in FIG. 4A are differently sized than the pins 420,422 in FIG. 4B. For example, the holes 402,404 and the pins 412,414 associated therewith could each have (about) a ¾ inch diameter, and the holes 406,408,410 and the pins 420,422,424 associated therewith could each have (about) a ½ inch diameter. In some examples, the arms 120,122 may have one or more additional sets of holes, and each set of such additional sets of holes may be sized to receive a different diameter pin, and each set of such additional sets of holes may allow adjustment of the gear rack 100 into two or more positions.

When using a ½ inch pin, for example, the first apertures 406 (of the second set of apertures 406,408,410) are pinned with the rotational pin 420, to define the axis of rotation of the gear rack 100 in that application (i.e., using ½ inch pins), and then the second aperture 408 and the third aperture 410 may be selectively pinned to retain the gear rack 100 in the vertical (stored) or horizontal (working) position, respectively. When using a ¾ inch pin, for example, the first apertures 402 (of the second set of apertures 402,404) are pinned, to define the axis of rotation of the gear rack 100 in that application (i.e., using ¾ inch pins), and then the second aperture 404 may be selectively pinned to retain the gear rack 100 in the vertical (stored) or horizontal (working) position.

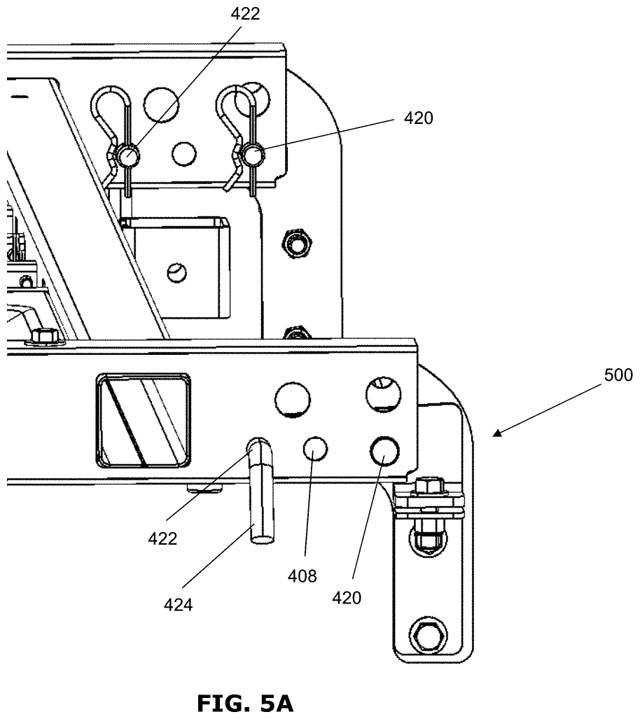

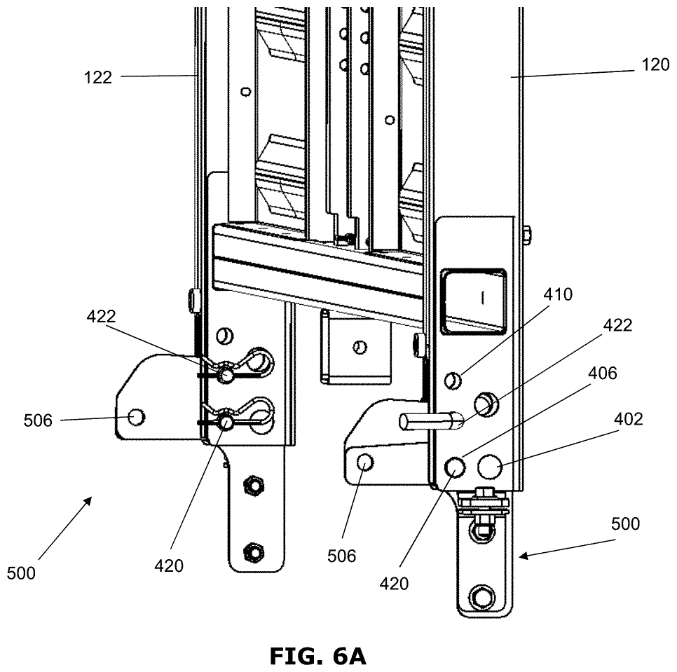

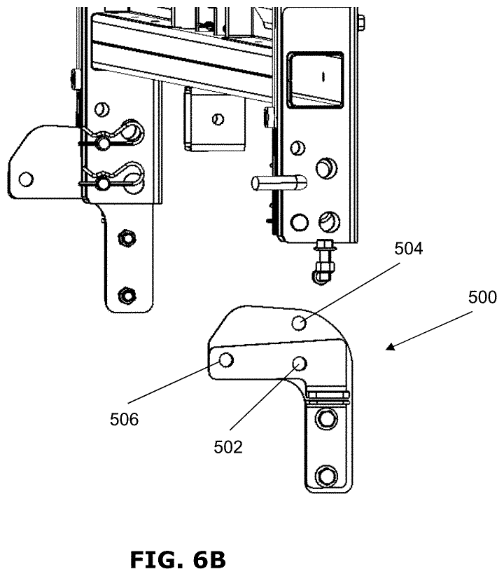

FIG. 5A illustrates a close up of the gear rack 100 attached to a bracket assembly or system 500 that adjustably connects or couples the gear rack 100 to the frame (not illustrated), according to one or more examples. The bracket system 500 may be configured for use with a certain size pins and, in one example, the bracket system 500 is configured for use with ½ inch pins. The bracket system 500 couples the gear rack 100 to the frame 110 with the pins, for example, as illustrated in FIG. 1D, thereby defining the hinges 124,126. FIG. 5B illustrates a partially exploded view of FIG. 5A, wherein one of the bracket systems 500 is shown unassembled from its corresponding arm 120,122. As further described, FIGS. 5A and 5B illustrate the gear rack 100 when in the working position. FIGS. 6A and 6B illustrate similar views as shown in FIGS. 5A and 5B, except that the gear rack 100 illustrated in FIGS. 6A and 6B is in the stored position.

As illustrated, a first pin (i.e., the rotational pin 420) is inserted to couple the arms 120,122 (including the inserts 304) to the bracket system 500 and to thereby define the axis of rotation of the gear rack 100. A second pin (i.e., the locator pin 422) may then be inserted into the arms 120,122 and the bracket system 500 to lock the gear rack 100 into its working or stored position.

In this example, the bracket system 500 includes a plurality of apertures or holes 502,504,506. The first aperture 502 is a rotational aperture configured to be aligned with the first holes 406 of the arms 120,122 (e.g., via the rotational pin 420), thereby defining the axis of rotation of the gear rack 100. The second and third apertures 408,410 of the arms 120,122 are locator apertures, either of which may be selectively aligned with the third aperture 506 or the second aperture 504 in the bracket system 500, by rotating the gear rack 100 into a horizontal orientation or vertical orientation, respectively, and may then be pinned together (e.g., via the locator pin 422) to retain the gear rack 100 in such position. Thus, when the arms 120,122 of the gear rack 100 are assembled on the bracket system 500, the first aperture 502 of the bracket system 500 will be aligned with and pinned to the rotational hole 406 in the arms 120,122 via the rotational pin 420. Then, when the gear rack 100 is in the horizontal orientation (as shown in FIGS. 5A-5B), the locator holes 410 of the arms 120,122 will be aligned with the third aperture 506 of the bracket system 500 and they may be pinned together via the locator pin 422; and, when the gear rack is moved into a vertical orientation (as shown in FIG. 1D), the locator holes 408 of the arms 120,122 will be aligned with the second aperture 504 of the bracket system 500 and they may be pinned together via the locator pin 422.

The bracket system 500 may be connected to the frame 110 such that the end-user may install the gear rack 100 by dropping the gear rack 100 onto the bracket system 500. In particular, the end user may pin the arms 120,122 onto the bracket system 500 such that the gear rack 100 is in either the vertical (stowed) or horizontal (deployed) position. In such examples, the end-user may recognize that the gear rack 100 is to be installed and adjusted using ½ inch pins due to the presence of the bracket system 500 existing on, or extending from, the frame 110. In the illustrated example, the bracket system 500 is configured to clamp onto the frame 110 which may include flanges (e.g., when the frame 110 is an I-beam or formed from a pair of “C” beams). Here, the bracket system 500 includes a bracket member 510 and a brace member 512. The bracket member 510 may include a surface or pivot point on which the arms 120,122 may pivot as they are moved between various positions. The bracket member 510 may also have various shapes depending on the type of frame it is to be connected and, here, it comprises a right angle shape. As shown in FIG. 1D, the brace member 512 may be attached to a side of the bracket member 510, such that the brace member 512 and the bracket member 510 may be fastened on either side of the frame member, such that the bracket system 500 clamps around or sandwiches the frame.

The gear rack 100 may be differently mounted in other examples. For example, the gear rack 100 may be configured to work with different attachment systems that are differently configured than the bracket system 500. As previously described, the bracket system 500 may permit utilization of ½ inch pins and, as detailed below, the gear rack 100 may be configured to work with different attachment mechanisms that utilize differently sized pins.

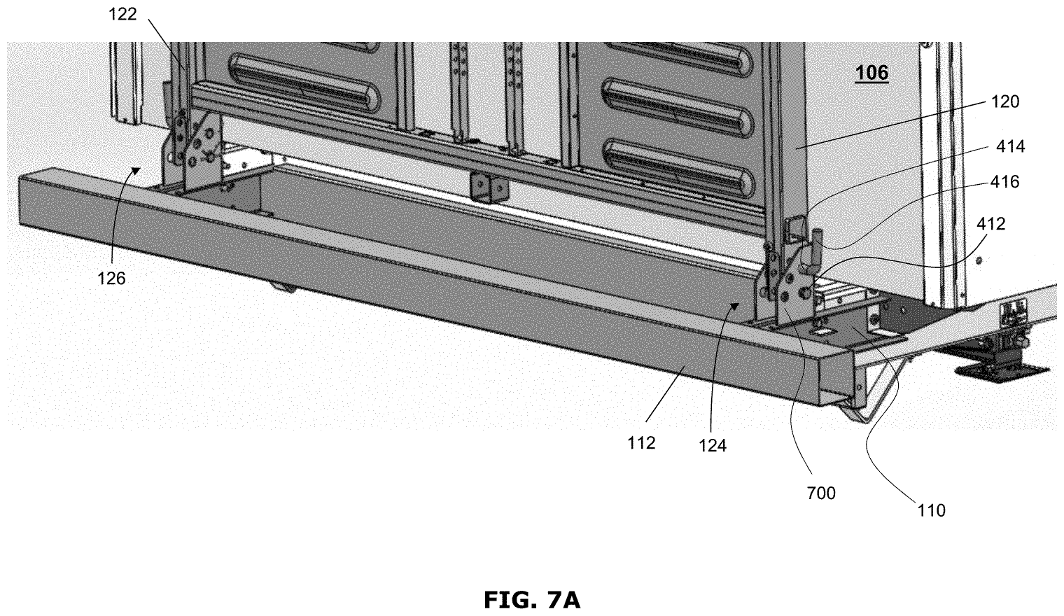

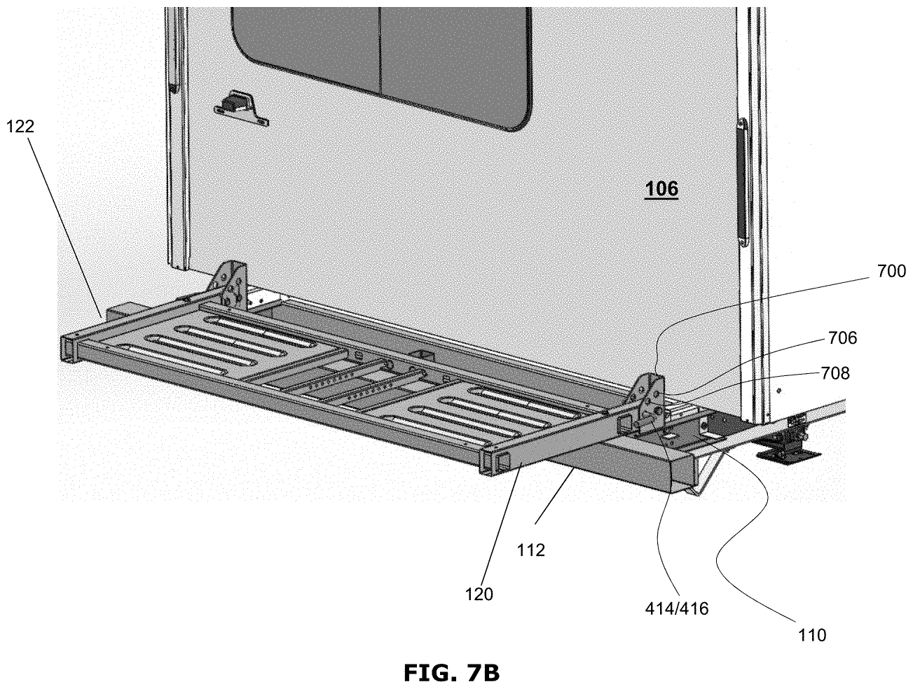

FIGS. 7A and 7B illustrate alternate examples of the gear rack 100 mounted to the frame 110 when in working and stored positions. In particular, FIGS. 7A and 7B illustrate an exemplary bracket system 700 configured to adjustably connect or couple the gear rack 100 to the frame 110, according to one or more examples. The bracket system 700 may be configured for use with a certain size pins and, in one example, the bracket system 700 is configured for use with ¾ inch pins. Thus, the rotational pin 412 and the locator pin 414 as described above with reference to FIG. 4A, may be utilized in this example to adjustably couple the gear rack 100 to the frame 110; however, other sized pins may be utilized with the bracket system 700.

The bracket system 700, which is sometimes referred to as a horn 700, connects the gear rack 100 to the frame 110 such that the gear rack 100 may be moved or adjusted into various positions, for example, the working (i.e., horizontal) position or the stored (vertical) position, or at one or more positions there-between or beyond. In some examples, a plurality of the horns 700 are utilized. The horn 700 is configured as a bracket or a shoe into which one of the arms 120,122 may be assembled. Similar to the bracket systems 500, the horns 700 may each include a plurality of apertures for receiving a pin (e.g., the rotational and locator pins 412,414). In the illustrated example, each of the horns 700 includes a plurality of apertures 702,704,706. Here, the aperture 702 in each of the horns 700 is a rotational aperture configured to align with the rotation hole 402 in the associated one of the arms 120,122 when the gear rack 100 is installed on the frame 110. The apertures 704,706 are locating apertures configured to align with the locating hole 404 of the arms 120,122 when the gear rack 100 is in its working (horizontal) position and its stored (vertical) position, respectively. Thus, the apertures 702,704,706 correspond to the first set of holes 402,404 and may therefore be correspondingly sized to receive the same sized pins. As mentioned, in some examples, the gear rack 100 may be configured to be positioned in more than just two (2) positions. Here, for example, the horns 700 each include a third locator aperture 708 that, when aligned with the locating aperture 404 of the arms 120,122 and held relative thereto via the locator pin 414, is positioned on the horn 700 to position the gear rack in a third position between the stored and working positions.

In the illustrated example, the locating apertures 704,706,708 in each of the horns 700 are arranged about the rotational aperture 702 to orient the arms 120,122 and thereby position the gear rack 100 in various positions (e.g., deployed or stowed positions, or an intermediate position there-between). Here, the rotational aperture 702 is configured to be pinned with the rotation holes 402 in the arms 120,122, and the first and second locator apertures 704,706 may each extend from the rotational aperture 702 along different trajectories that define the various different positions at which the gear rack 100 may be secured. Here, the first locator aperture 704 extends from the rotational aperture 702 at a horizontal orientation, and the second locator aperture 706 extends from the rotational aperture 702 at a vertical orientation. Thus, when the arms 120,122 are pinned to the horn 700, the rotational pin 412 extends through the rotational hole 402 of the arms 120,122 and the rotational aperture 702 of the horn 700, allowing the gear rack 100, together with the locating hole 404 thereon, to be rotated into alignment with either the first and second locator aperture 704,706 of the horn 700 (or any additional locator holes such as locator aperture 708). Then, the gear rack 100 may be rotated into the working (horizontal) position, where the locator hole 404 of the arms 120,122 may be aligned with and pinned to the first locator aperture 704, or the gear rack 100 may be rotated into the stored (vertical) position, where the locator hole 404 may be aligned with and pinned to the second locator aperture 706. Once the gear rack 100 has coupled to the horn 700 via rotational pin 412, the gear rack may be rotated into a position and then secured at that position by inserting the locator pin 414 through the locating hole 404 and the locating aperture 704 (e.g., when in working position) or through the locating hole 404 and the locating aperture 706 (e.g., when in the stored position). When the end-user installing the gear rack 100 encounters an application where the frame includes a mounting means such as the horns 700 described herein, the end-user may recognize that a certain sized pin are to be utilized with the appropriately sized set of apertures on the arms 120,122 (e.g., apertures 402,404). However, if a different mounting means is provided, such as the bracket system 500 described herein, the end-user may recognize that a different sized pin (e.g., a half-inch pin) is to be utilized with the appropriately sized set of holes on the arms 120,122 (e.g., holes 406,408,410), and then mount the gear rack 100 with the appropriate hardware.

The gear rack 100 is modular too. Not only is the gear rack 100 configured to be dropped on to frames 110 having different mounting configurations, for examples, as explained in FIGS. 4A and 4B, but the gear rack 100 is modular in that various other items may be installed on the gear rack 100. As described below, various assemblies may be installed on the gear rack 100, such as recreational equipment assemblies described below. Also, various types of mountable equipment may be installed on the gear rack 100, such as, mountable grills, tables, picnic tables, etc.

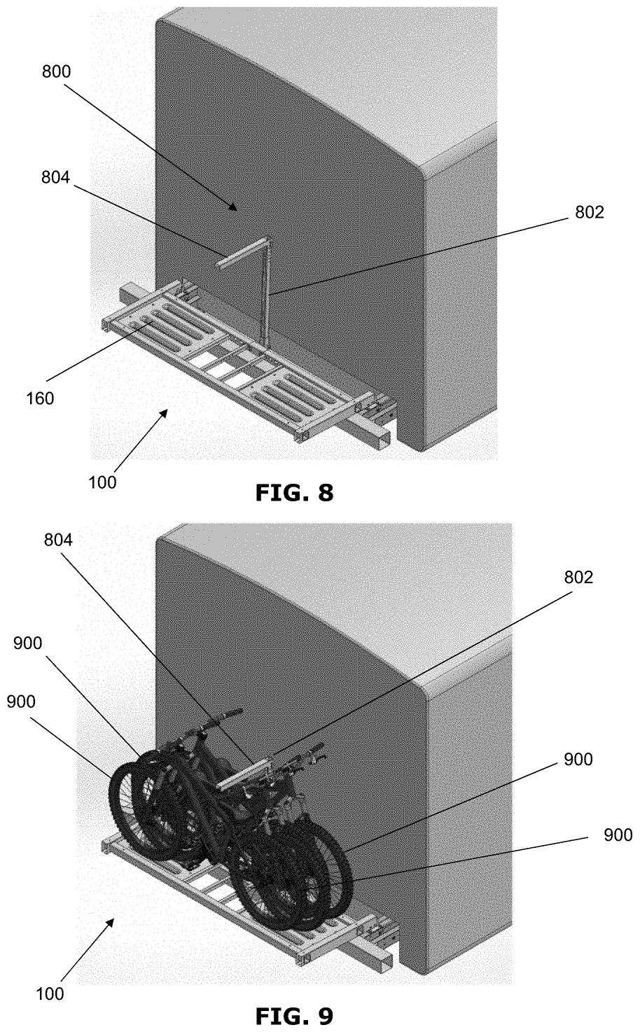

FIG. 8 illustrates the gear rack 100 of FIG. 1, when in a deployed (or extended or un-folded) position, having a bicycle support structure 800, according to one or more embodiments of the present disclosure. The bicycle support structure 800 is configured to be connected to the accessory mount 170. In the illustrated example, the bicycle support structure 800 is an “upside-down L-shaped member” having a vertical member 802 and a horizontal member 804. As shown, the vertical member 802 is secured to the adapter 172 of the accessory mount 170 and the horizontal member 804 longitudinally extends from an upper end of the vertical member 802. As further described below, the horizontal member 802 of the bicycle support structure 800 may help maintain one or more articles of equipment on the gear rack 100, for example, one or more bicycles. In some examples, the horizontal member 804 is adjustable such that its vertical position along the vertical member 802 may be modified or adjusted to accommodate differently sized bicycles or equipment. For example, the horizontal member 804 may include an integral sleeve arranged over the vertical member 802, and/or the vertical member 802 may comprise two (2) or more telescoping shafts, or the horizontal member 804 may be selectively secured within recesses arranged at various heights on the vertical member 802, etc.

FIG. 9 illustrates the gear rack 100 of FIG. 8 having four (4) bicycles 900 stored thereon. Here, the bicycles 900 have wheels resting in the wheel wells 160 and top tubes resting beneath the horizontal member 804 of the bicycle support structure 800.

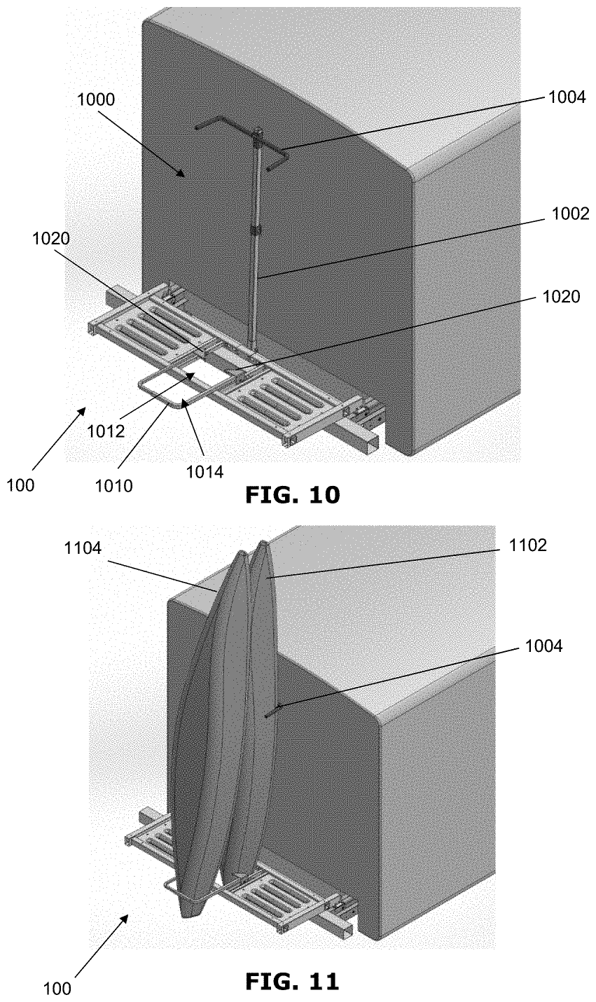

FIG. 10 illustrates the gear rack 100 of FIG. 1, when in a deployed (or extended or un-folded) position, having a kayak support structure 1000, according to one or more embodiments of the present disclosure. The kayak support structure 1000 is configured to be connected to the accessory mount 170. In the illustrated example, the kayak support structure 1000 includes a vertical member 1002 and a retaining member 1004 configured to receive one or more kayaks. As shown, the vertical member 1002 is secured to the adapter 172 of the accessory mount 170 and the retaining member 1004 longitudinally extends from an upper end of the vertical member 1002. As mentioned, the retaining member 1004 of the kayak support structure 1000 may help maintain one or more articles of equipment on the gear rack 100, for example, one or more kayaks. In some examples, the retaining member 1004 is adjustable such that its vertical position along the vertical member 1002 may be modified or adjusted to accommodate differently sized kayaks or equipment. For example, the retaining member 1004 may include an integral sleeve arranged over or within the vertical member 1002, and/or the vertical member 1002 may comprise two (2) or more telescoping shafts, etc. The kayak support structure 1000 may also include a window bracket 1010 that defines windows for placing kayaks. The window bracket 1010 may be connected to the gear rack 100, for example, at two (2) of the interior frame members 142. When arranged over the frame of the gear rack 100, the window bracket 1010 may define a plurality of windows. In the illustrated examples, when arranged over the cross-member 130, the window bracket 1010 defines a first and second window 1012,1014. The windows 1012,1014 may be sized to receive an end of a kayak in a manner that inhibits the kayak from falling through the window, 1012,1014. Thus, the windows 1012,1014 are configured to have an “interference fit” with an end of a kayak. Accordingly, in some examples, either or both of the windows 1012,1014 are adjustable in size. In the illustrated example, a pair of adjustment members 1016 are arranged on the window bracket 1010 and/or on the interior frame members 142 (e.g., attached to mounting holes 145) to reduce the size of the window 1012 so as to better accommodate the kayak end. The adjustment members 1016 have a contact surface that may be designed to accommodate the specific equipment or gear to be stored and, in the illustrated example, the adjustment members 1016 each include an angled contact surface that is configured to accommodate an angled side at the end of the kayak as illustrated below. In some examples, the adjustment members 1016 may also (or instead) be installed in the other window 1012.

FIG. 11 illustrates the gear rack 100 of FIG. 10 having two (2) kayaks 1102,1104 stored thereon. Here, the kayaks 1102,1104 have lower ends resting within windows 1012,1014 defined within the gear rack 100 by the window bracket 1010 and upper ends resting within a space defined within the retaining member 1004 of the kayak support structure 1000.

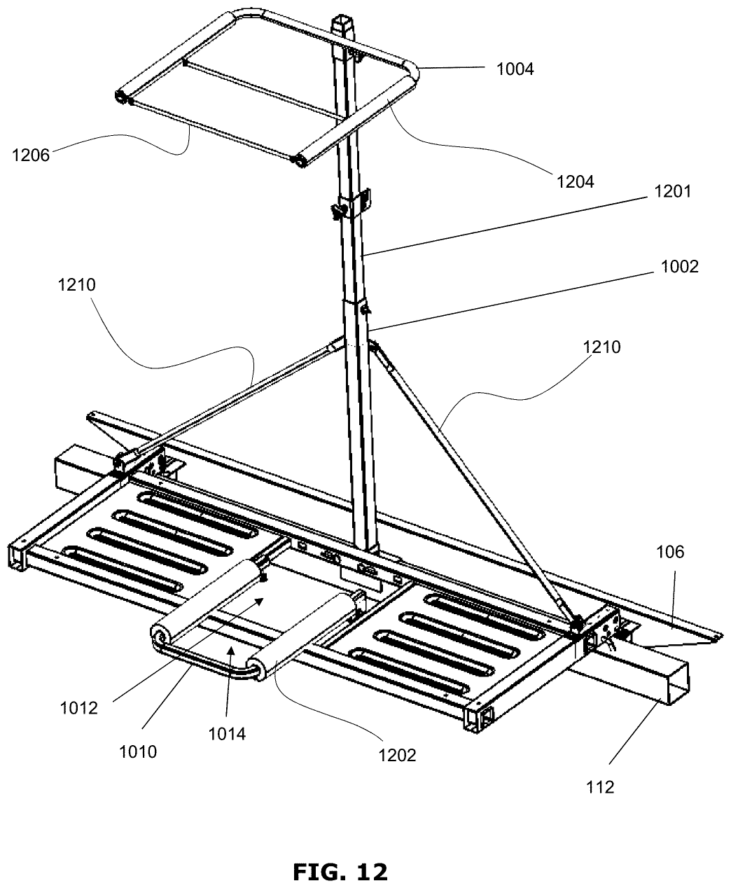

FIG. 12 illustrates an alternate configuration of the gear rack 100 for supporting the kayaks 1102,1104. As illustrated, a shaft 1201 extends from the vertical member 1002, and the shaft 1201 may telescope within the vertical member 1002 so as to adjust the vertical elevation of the retaining member 1004 and, in some examples, the shaft 1201 may be configured as a telescoping shaft assembly itself (i.e., with a sleeve and telescoping portion) to further adjust the vertical elevation of the retaining member 1004. For example, the shaft 1201 may be pinned within the vertical member 1002 to provide the retaining member 1004 at various vertical orientations and/or the shaft 1201 may have a sleeve and telescoping shaft portion that may be pinned at various locations within the sleeve (of the shaft 1201) to provide the retaining member 1004 at various vertical orientations. Also, the gear rack may include cushions 1202,1204 arranged on the window bracket 1010 and on the lateral arms of the retaining member 1004. Here, the cushions 1202,1204 are sleeves arranged over portions of the window bracket 1010 and on the retaining member 1004, but may be differently provided. Also, a pair of straps or bungee cords 1206 may be arranged on the retaining member 1004 to help maintain any kayaks therein. Here, for examples, a pair of the bungee cords 1206 extend between the lateral arms of the retaining member 1004, and are removable to allow positioning of the kayaks between the lateral arms of the retaining member 1004 after which the bungee cords 1206 may be strapped into place to secure the upper end of the kayaks. Moreover, the gear rack 100 may include supports 1210 configured to support and brace the kayak support structure 1000.

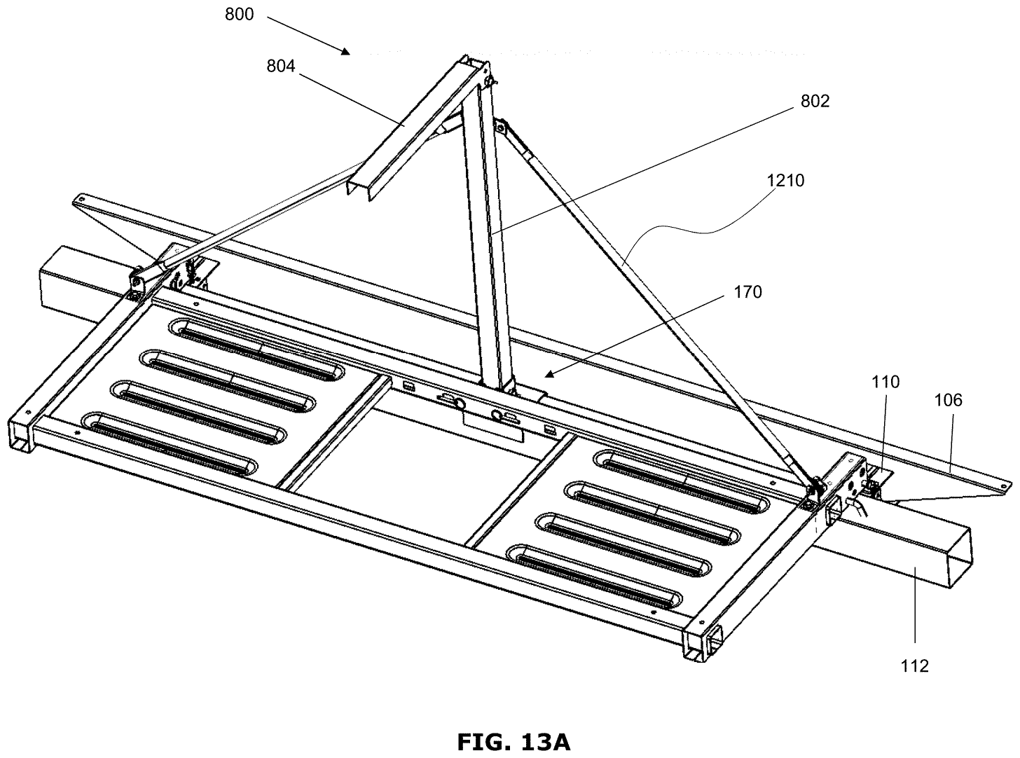

FIGS. 13A-13C illustrate an alternate configuration of the gear rack 100 for supporting the bicycles 900. The vertical member 802 may be similar to the vertical member 1002, such that the kayak support structure 1000 previously described may be installed therein. Here, however, the horizontal member 804 is pinned to the vertical member 802. FIG. 13B illustrates an exemplary coupling of the horizontal member 804 to the vertical member 802, where the horizontal member 804 may be pinned into a horizontal position where it may retain or support a bicycle and a stowed position where it positioned proximate to the vertical member 802. Here, the horizontal member 804 is a channel member that defines an interior channel, and the vertical member 802 is received within or nests within the horizontal member 804 when the horizontal member 804 is in the stowed position. FIG. 13C illustrates the accessory mount 170, according to one or more embodiments. Here, the accessory mount 170 includes a base 1302 configured to rest or be supported on the bumper 112; however, in other examples, the base 1302 may be supported elsewhere on the gear rack 100 and/or the vehicle (e.g., the frame 110 or on other structure of the vehicle). As shown, the adapter portion 172 is connected to the base 1302 and is configured to receive member such as the vertical member 802, however, the adapter portion 172 may connect to other portions, such as the vertical member 1002.

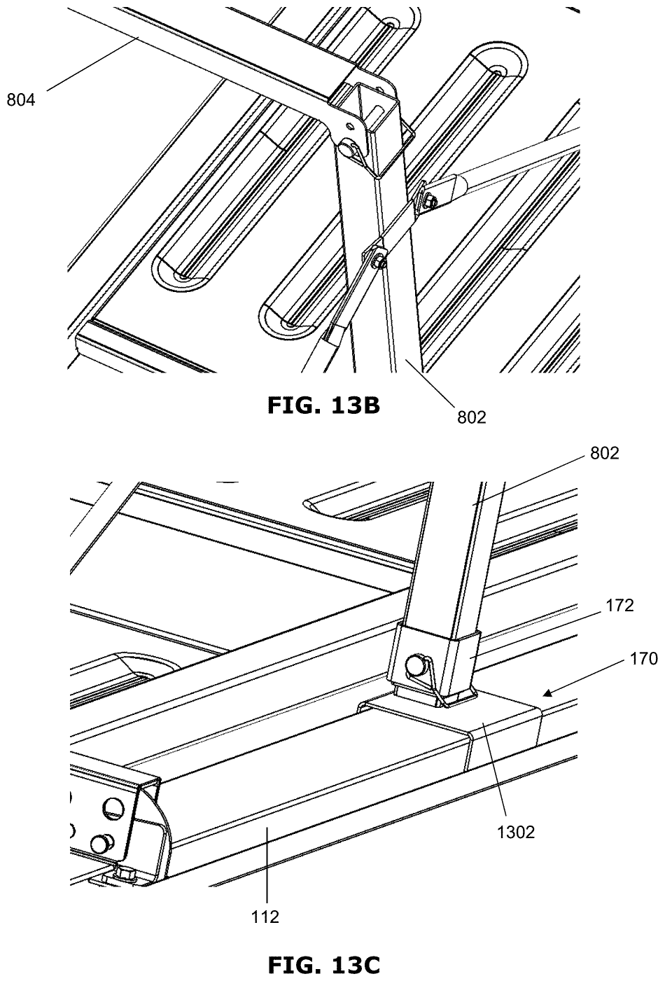

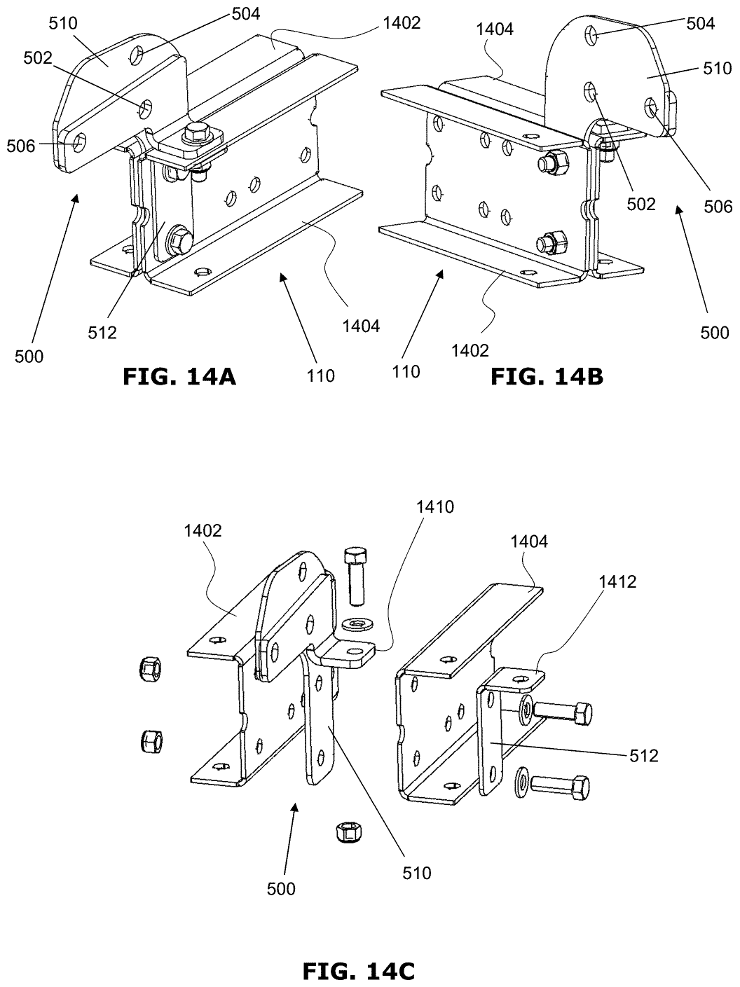

FIGS. 14A-14C illustrate operation of the bracket system 500, according to one or more embodiments. In these examples, the frame 110 is a two-part frame comprised from a pair of frame members 1402,1404. Here, each of the frame members 1402,1404 is a “C” shaped frame member that secured together. As shown in the exploded view of FIG. 14C, the bracket system 500 is nested between the frame members 1402,1404. In particular, the bracket member 510 is installed between the interior surfaces of the pair of frame members 1402,1404, and the brace member 512 is clamped on to an exterior surface of one of the frame members 1402,1404. When assembled, fasteners may be provided through the brace member 512, the frame member 1404, the bracket member 510, and the other frame member 1402. Also, the bracket member 510 includes a tab member 1310 configured to rest on a top flange of one of the frame members 1402,1404, the brace member 512 includes a corresponding tab member 1412 configured to rest underneath the top flange of one of the frame members 1402,1404. When assembled, a fastener may be provided through the tab member 1410, the flange of the frame member 1404, and the corresponding tab member 1412.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The use of directional terms such as above, below, upper, lower, upward, downward, left, right, top, bottom, and the like are used in relation to the illustrative embodiments as they are depicted in the figures, the upward direction being toward the top of the corresponding figure and the downward direction being toward the bottom of the corresponding figure.

What is claimed is:

1. A gear rack for a vehicle frame, the gear rack comprising:
a structure rotatably coupled to the vehicle frame, the structure supporting at least one tray defining an upper cargo surface.

2. The gear rack of claim 1, wherein the at least one tray includes a plurality of wheel wells formed into the upper cargo surface.

3. The gear rack of claim 2, wherein the wheel wells are recessed into the upper cargo surface and extend beyond a lower surface of the tray opposite the upper cargo surface.

4. The gear rack of claim 1, wherein the structure includes a pair of arms configured to rotatably couple the structure to the vehicle frame.

5. The gear rack of claim 4, wherein the pair of arms support the tray.

6. The gear rack of claim 4, wherein the pair of arms each include an insert at an end of the arm where it is rotatably coupled to the vehicle frame.

7. The gear rack of claim 4, wherein the pair of arms each include at least one set of holes, with each set of the at least one set of holes including a rotational hole and at least one locator hole, and each set of the at least on set of holes is arranged to correspond with a corresponding set of apertures associated with the trailer frame, wherein the corresponding set of apertures associated with the trailer frame are fixed in position relative to the trailer frame.

8. The gear rack of claim 7, wherein the corresponding set of apertures associated with the trailer frame are provided in a bracket assembly and/or in a horn assembly.

9. The gear rack of claim 4, wherein the structure includes a pair of cross-members supported between the pair of arms.

10. The gear rack of claim 9, wherein the structure includes one or more struts supported between the pair of cross-members.

11. The gear rack of claim 10, wherein the cross-members and the one or more struts are configured for the one or more struts to be removably installed at one or more positions between the cross-members, such that the one or more struts may be removed from a first position between the cross-members and reinstalled at a second position between the cross-members.

12. The gear rack of claim 1, further comprising a recreational equipment assembly, wherein the recreational equipment assembly is selected form the group consisting of a bike assembly and a kayak assembly.

13. The gear rack of claim 1, wherein a rotational pin rotatably couples the structure to the vehicle frame whereby the structure may rotate about an axis of the rotational pin relative to the vehicle frame.

14. The gear rack of claim 13, wherein a locating pin locks the structure, relative to the vehicle frame, in one or more positions where the structure radially extends from the axis of the rotational pin.

15. The gear rack of claim 14, wherein the locating pin may lock the structure in a first position where the structure is vertical or in a second position where the structure is horizontal.

16. The gear rack of claim 1, wherein the at least one tray defines an opening configured to receive an end of a kayak.

17. A gear rack for a vehicle having a frame, the gear rack comprising:
a platform coupled to the frame at a hinge, wherein the platform defines a cargo surface and may be oriented in one or more positions relative to the frame depending on an alignment between the platform and the hinge, and wherein a plurality of wheel wells are stamped into the cargo surface.

18. The gear rack of claim 17, wherein the platform is oriented in a first position relative to the frame when a locator hole of the platform is moved into alignment with a first locator aperture of the hinge, and wherein the platform is oriented in a second position relative to the frame, which is different from the first position, when a second locator hole of the platform is moved into alignment with a second locator aperture of the hinge.

19. The gear rack of claim 17, wherein the platform is oriented in a first position relative to the frame when a locator hole of the platform is moved into alignment with a first locator aperture of the hinge, and wherein the platform is oriented in a second position relative to the frame, which is different from the first position, when the locator hole of the platform is moved into alignment with a second locator aperture of the hinge.

20. The gear rack of claim 17, wherein the platform includes at least one removable strut.
